(19) United States
(12) Patent Application Publication
(10) Pub. No.: US 2010/0282735 A1
(43) Pub. Date: Nov. 11, 2010

(54) ELECTRIC HEATER FOR CLOTHES DRYER

(76) Inventors: Claudio Fattorel, Vittorio Veneto (IT); Mirco Celot, Conegliano (IT); Roberto Colombo, Conegliano (IT)

Correspondence Address: SAMPSON & ASSOCIATES, P.C., 50 CONGRESS STREET, BOSTON, MA, 02109, US

(21) Appl. No.: 12/774,022

(22) Filed: May 5, 2010

(30) Foreign Application Priority Data
May 6, 2009 (IT) RM2009A000221

(51) Int. Cl. H05B 3/06

(52) U.S. Cl. 219/520

(57) ABSTRACT

The electric heater for clothes drying devices, object of the present invention, does not require the large dimensions currently required to provide high powers. Moreover, the particular shape of the resistive element reduces the vibrations transmitted to the apparatus and, therefore, the noise perceived by the user. The particular zigzag shape of the heater determines a lesser tendency for dust to be deposited on the heating element and increases safety against short circuits in case of filament breaking and/or wire deformation occurring when the same is subjected to high operating temperatures.

### RELATED APPLICATION

This application claims priority to Italian Patent Application No. RM2009A000221, filed on May 6, 2009.

### FIELD OF THE INVENTION

The present invention relates to an electric heater used in clothes drying devices.

### STATE OF THE ART

Various electric heaters used in clothes drying devices are known.

Some known electric heaters have at least one coil-shaped wire, e.g. helix wound, mounted to a supporting structure.

Although these electric heaters with a coil-shaped wire are commonly used in clothes drying devices, they have some disadvantages.

A first disadvantage is that large sized heaters are required to supply a sufficient heating power, e.g. more than 5 kW.

A second disadvantage is that the air flow passing through the coil-shaped wires may cause vibrations in the wires and therefore an annoying noise during operation.

A further disadvantage is due to the coil-shaped heating wires tending to bend, because of the temperature and their weight.

Therefore there is a need to make an electric heater for clothes dryers which allows to overcome the aforesaid drawbacks.

### SUMMARY OF THE INVENTION

It is the primary object of the present invention to provide an electric heater for clothes dryer which allows to overcome the aforementioned drawbacks in a simple and functional manner. Such a heater has a compact structure comprising at least one resistive element with circular section and bent in a “zigzag” manner, supported by a multi-layer structure made of insulating material.

It is another object of the invention to provide an electric heater which simplifies the application thereof to the apparatus in use while ensuring a high safety level against short circuits in case of filament breaking and/or wire deformation which occurs when the same is subjected to high operating temperatures, and which has a lesser inclination for dust to be deposited on the heating element.

Therefore the present invention aims at achieving the above-discussed objects by providing an electric heater for clothes drying devices which, in accordance with claim 1, comprises at least one resistive element, a supporting structure to support said at least one resistive element, in which said at least one resistive element comprises a circular-section filament bent so as to define two series of flat U-shaped turns, a first series of turns being arranged on a first plane which is transversal to the supporting structure and a second series of turns being arranged on a second plane which is transversal to the supporting structure and substantially parallel to the first plane, the filament being bent at said supporting structure so that a turn on said first plane is followed by a turn on said second plane.

The supporting structure is formed by one or more layers of insulating material and is shaped so as to allow the resistive element or elements to be fastened. These elements substantially are of a similar shape and arranged in an overlapping manner in the variant of the multi-layer supporting structure.

The supporting structure may consist of a single element or alternatively, in a peripheral direction, it may consist of a plurality of straight or curved segments. In this second case, each segment is integrally fixed to another adjacent segment.

An alternative embodiment of the heater includes a single supporting element on which a plurality of segments is fixed.

Advantageously, according to the heater of the present invention, large dimensions are no longer required to obtain high heating powers. Moreover, the particular shape of the resistive element reduces the vibrations transmitted to the apparatus and, therefore, the noise perceived by the user.

An alternative embodiment of the invention provides for the possibility of inserting several resistive elements on the structure, so as to partialize the total power with the consequential energy savings in the case of incomplete loads of clothes in the dryer, or require lower temperatures of the heated air, according to the type of materials to be dried.

A further alternative embodiment of the invention provides for the possibility of positioning the resistive elements towards an optimal side, e.g. only on the internal side or only on the external side or on both sides, with respect to the structure formed by the flat supporting parts of the heater, by adapting the heater itself to the specific needs of the apparatus.

A first embodiment includes a single resistive element, for example, arranged outside or inside the supporting structure. A second embodiment includes, instead, the supporting structure being arranged in the middle of the resistive element so that one part of the latter is arranged outside the supporting structure and another part of the resistive element is arranged inside said supporting structure.

Other variants may be obtained by providing for the possibility of varying the final geometry of the heater by using a single supporting structure with the advantage of being able to use the same resistance on apparatuses of different size, thus avoiding costs for specific equipments.

The dependent claims describe preferred embodiments of the invention.

### BRIEF DESCRIPTION OF THE DRAWINGS

Further features and advantages of the invention will be more apparent in light of the detailed description of a preferred, but not exclusive, embodiment of an electric heater, shown by way of non-limiting example, with the aid of the accompanying drawings in which:

FIG. 1 depicts a diagrammatic top view of an electric heater according to the invention;

FIG. 2 depicts a cross section of a segment of the electric heater in FIG. 1;

FIG. 3 depicts an enlarged view of detail E of the electric heater in FIG. 1;

FIG. 4 depicts a diagrammatic, partial view of a resistive element in an intermediate manufacturing step, intended to be inserted on the structure of the electric heater in FIG. 1;

FIG. 5 depicts a view along arrow L in FIG. 7 of the resistive element bent in its final shape in a manufacturing step following that in FIG. 4;

FIG. 6 depicts a view along arrow V in FIG. 5 of the resistive element;

FIG. 7 depicts a view along arrow H in FIG. 5 of the resistive element;

FIG. 8 is a view along arrow H in FIG. 5 of the resistive element corresponding to that in FIG. 7, when mounted to a supporting part of the structure of the electric heater according to the invention;

FIG. 9 is a view along arrow Y in FIG. 10 of an enlarged detail of a second variant of the resistive element mounted to a supporting part of the structure of the electric heater according to the invention;

FIG. 10 is an enlarged view along arrow Z of the detail of the electric heater in FIG. 9;

FIG. 11 is an enlarged view of detail F of a further embodiment of the electric heater of the invention in FIG. 12;

FIG. 12 illustrates a side view of a further embodiment of the electric heater in accordance with the invention.

### DETAILED DESCRIPTION OF PREFERRED EMBODIMENTS OF THE INVENTION

With reference to the figures a preferred embodiment of an electric heater is depicted, globally indicated by numeral 1, and particularly usable in clothes drying devices.

The heater 1 of the present invention comprises at least one or more resistive elements 8, also simply referred to as resistances, arranged in a supporting structure 6 of heater 1 (better disclosed hereinafter).

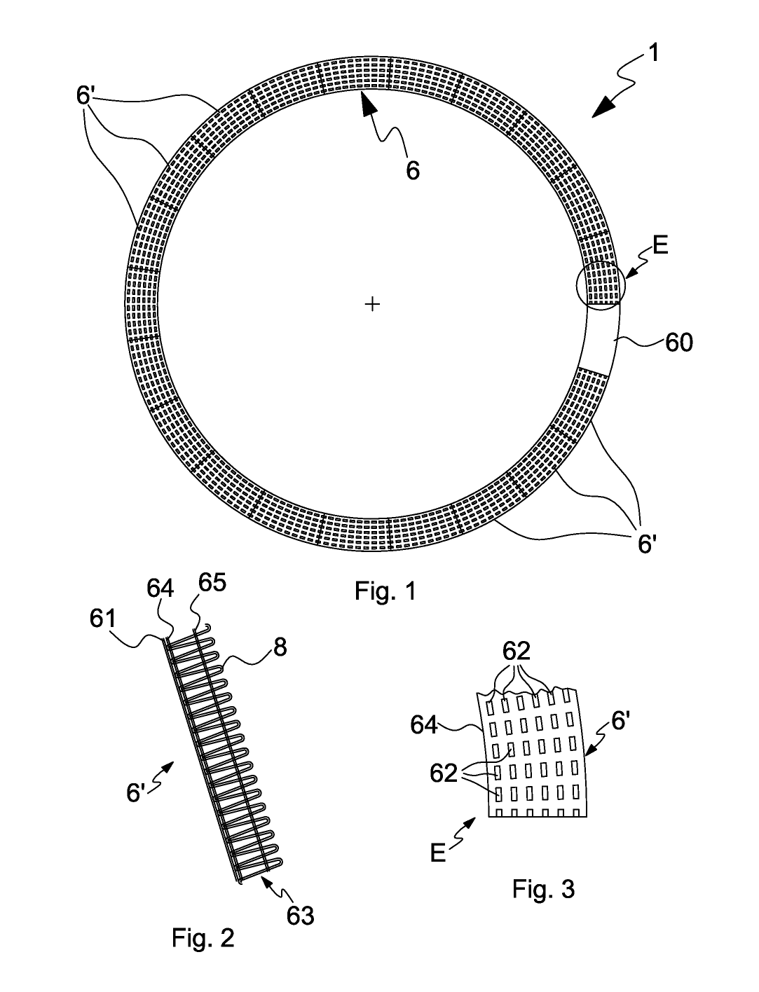

According to the disclosed embodiment, the supporting structure 6 consists of a plurality of flat parts or segments 6′ of various shapes, e.g. having a circular or more generally curved sector, or having a straight segment, each of which being interconnected with the adjacent flat parts 6′. The set of flat parts 6′ forming the supporting structure 6 of a convenient shape is adapted to be inserted into a corresponding housing provided in the clothes dryer. FIG. 1 illustrates the heater in a round shape as it results from the assembly of segments 6′ having a circular sector shape.

As shown in FIG. 1, the supporting structure 6 has a part 60 without resistive wire in order to access the electrical interconnections, the terminals of the heating elements and the power supply of the heating elements 8.

Segments 6′ are advantageously made of an insulating material, preferably mica, having high dielectric strength and excellent chemical stability. Other usable insulating materials may be ceramic materials, such as steatite or cordierite.

As shown in the variant in FIG. 2, each part 6′ is formed by two layers 61, 64 of suitable dielectric/insulating material, such as mica or other equivalent material.

As shown in FIG. 3, layer 64 has a plurality of ports 62 adapted to house and support a respective plurality of turns of the resistive element 8, or of a plurality of resistive elements arranged so as to be concentric or parallel to one another.

The arrangement is such that the two mica layers 61, 64 are substantially arranged adjacent to each other, so as to withhold end parts of the turns of the resistive element 8 therebetween.

The variant in FIG. 2 provides a further support 65, similarly shaped to layers 61 and 64, which is arranged in a distal position from the two layers 61, 64 so as to create a further support to the resistive element 8 and further allow an air passage conduit 63 to be created between the two layers 64 and 65 to further improve the thermal yield of the heater.

As shown in the figures, structure 6 is obtained assembling the plurality of segments 6′ in an interconnected manner and by interconnecting the respective plurality of heating elements 8, in the variant in which the resistance consists of separate segments held to one another. Thereby, a surface overlapped by the resistance(s) 8 bent in the shape of meanders or zigzag is generated, said resistance(s) being brushed in use by the air to be heated, while passing it through the heater 1 by means of forced circulation. The design temperature of the electric heater 1 in operating condition is 400° C., for example, and the air quickly heats up thus allowing the clothes placed in the compartment of the electrical household appliance to be dried.

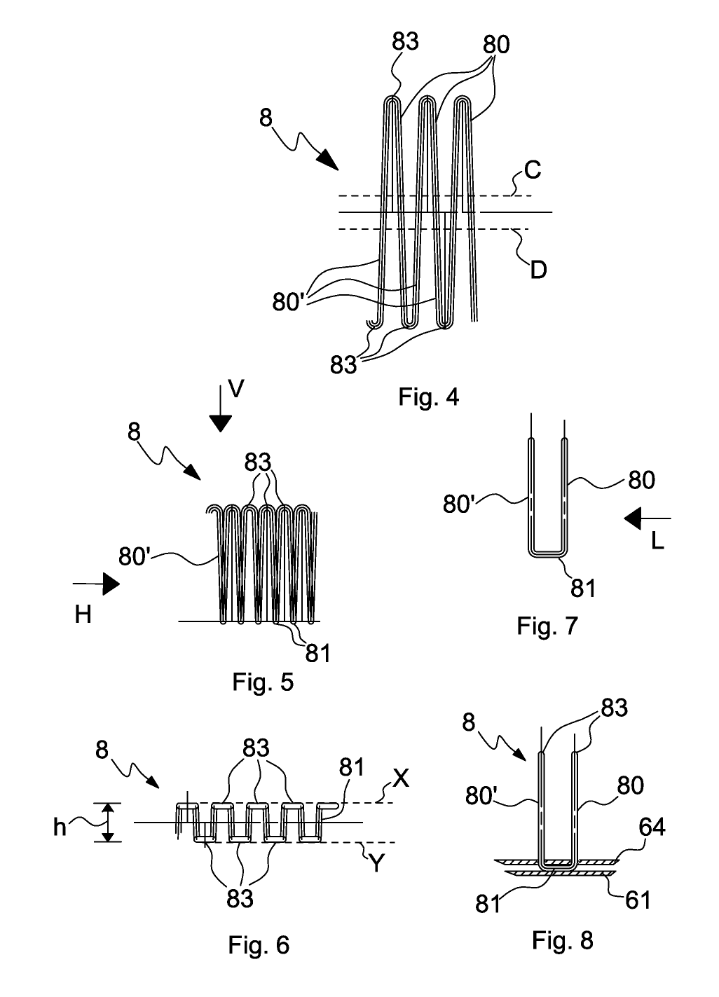

Now, with reference to FIG. 4, an intermediate manufacturing step of resistance 8 is shown, in which the wire lays on a plane coinciding with the plane of the figure and is zigzag bent while keeping it on said plane. The subsequent step of manufacturing the resistance 8 includes bending all side sections 80 of the zigzag by 90° about the straight line C in the direction facing the observer of the figure. The same bending operation is carried out on the side sections 80′ of the zigzag in the rotation direction about the straight line D towards the observer of FIG. 4. In this case, the final conformation taken by resistance 8, seen from the side, is that shown in FIG. 5.

As can be seen, with particular reference to the various views in FIGS. 6, 7 and 8, the resistive element 8 consists of a circular-section filament having a plurality of turn sections 80, 80′, 81, 83, and in which the turns are adjacent to one another in a substantially parallel or slightly inclined position. More precisely, each of these filament turns forming the resistive element 8 has a substantially flat U shape, both in the side view along arrow H and in the top view along arrow V, i.e. with a turn end section 81 being shorter and which is straight, the length of which is indicated by “h”, and which is substantially arranged so as to be orthogonal to the longer turn sections 80 and 80′.

Thereby, due to this particular shape of resistance 8, a heating element capable of optimally transmitting the heat to the air flowing between the zigzags may be made with a single resistive wire, as the turn sections 80, 81′ may be distributed in a much more dense manner. Moreover, the manufacturing of resistance 8 is much more facilitated by the particular cross-section of the resistive wire and by the particular shape of the bends.

Due to the particular conformation of the turns each apex or end section 81, 83 of turn, substantially consisting of straight sections, may be advantageously housed between the two layers 61 and 64 of structure 6 and here withheld, thus blocking the resistive element 8.

Here, it should be noted that the bending of resistance 8 and the short circuits, even in case of resistance breaking, are avoided due to the shape of the resistances or heating elements 8, as well as due to the fact that turn sections 81 are connected between two layers 61 and 64 of the supporting structure 6, and are kept spaced apart from one another by said two layers 61, 64. The arrangement of the resistances in accordance with the invention allows a higher heating power even with strong air flows having only minimum vibrations produced.

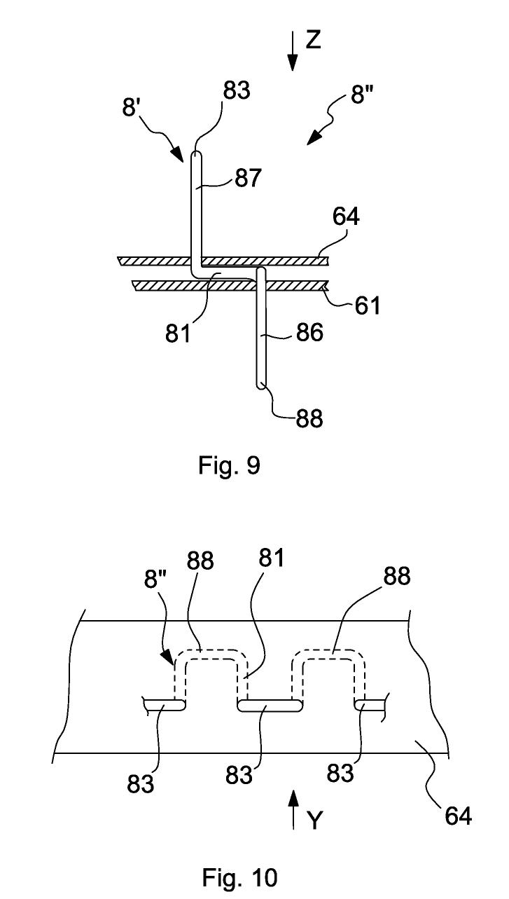

A further embodiment of the electric heater of the invention is shown in FIG. 9, in which the layers 61 and 64 fix a resistance 8′ having a different shape from the resistance 8 of the above-described variant. In this case, the resistance may be referred to as a S-shaped resistance, when seen in a side view as that in FIG. 9. In this further variant, resistance 8′ is zigzag bent, with each end section alternatively arranged above and below the two layers 61 and 64.

In this variant, it is also apparent that the layer 61 should be provided with holes to allow the part of resistance 8′ to pass from the part opposite to layer 64. Alternatively to the bending of the above-described type protruding from the external part of layer 61, whereby the end portions 83 and the straight sections 87 of the turns protrude, this particular bending shape provides for the successive bending, after a central section 81 tightened between the layers 61 and 64, to protrude from the external part of the layer 64, whereby the straight turn sections 86 and the end portion 88 protrude beyond the layer 61. The successive bending of resistance 8′ is then similarly rearranged as before.

FIG. 10, seen along arrow Z in FIG. 9, diagrammatically shows the parts of resistance 8′ protruding out of the layer 64, drawn by means of a continuous line, and the parts which are on the opposite part of layer 64, which are drawn instead by means of a broken line.

Similarly to the variant illustrated above in FIG. 2, a further insulating layer may also be added in this variant of FIGS. 9 and 10, at a certain distance from layer 64 or from layer 61 so as to further reinforce the heater and create an air passage channel between the insulating layers.

Even though not shown in the figures, the mica layers 61, 64, 65 may be held so as to be integral with one another by means of rivets or other suitable fixing means. The mica layers 61, 64, 65 provide electric insulation and avoid the resistances 8 and 8′ from coming in contact with one another or with parts of the electrical household appliance once the heater of the invention has been installed. This configuration of the resistances 8 and 8′, arranged on planes which are substantially perpendicular to support 6 and substantially parallel to the bottom, advantageously allows to offer the least resistance possible to the air flow by optimizing the thermal yield and the load loss.

For example, the resistive elements 8 may have a diameter of 0.95 mm, preferably between 0.7 and 1.5 mm, and may be made of materials such as for example resistive FeCrAl—FeNiCr alloys or in any case alloys suitable for the use required.

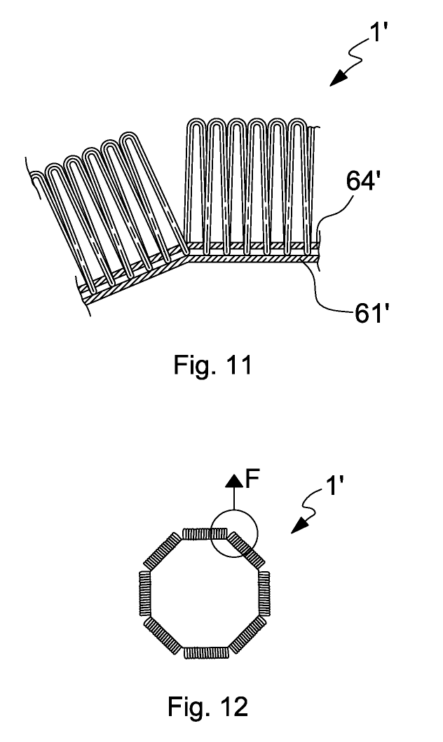

Due to the particular simplicity of manufacturing the resistance 8 and 8′, a variant in accordance with the invention of the electric heater 1′ shown in FIG. 12 and FIG. 11 may be provided, which shows an enlargement of detail F, in which the layers 61′ and 64′ consist of flat segments and form a prismatic tubular structure having a predetermined axial length depending on the number of resistances used in the heater 1′. In this case, the turns of the heating resistance are directed in a substantially radial direction, perpendicular to the axis of the tube. They may be facing both the inside and the outside of the prismatic tube, or may develop in both the internal and external directions (not shown).

The elements and features disclosed in the various preferred embodiments may be combined without however departing from the scope of protection of the present application.

1. An electric heater for clothes dryer devices comprising:
at least one resistive element,
a supporting structure for supporting said at least one resistive element, wherein said at least one resistive element comprises a circular section filament bent so as to define two series of flat U-shaped turns, a first series of turns being arranged on a first plane which is transversal to the supporting structure and a second series of turns being arranged on a second plane which is transversal to the supporting structure and substantially parallel to the first plane, the filament being bent at said supporting structure so that a turn on said first plane is followed by a turn on said second plane.

2. A heater according to claim 1, wherein the supporting structure is formed by at least two overlapping layers made of insulating material.

3. A heater according to claim 2, wherein one of said at least two layers has a plurality of ports adapted to accommodate and support a respective plurality of turns of the resistive element.

4. A heater according to claim 2, wherein each of said at least two layers has a plurality of ports adapted to accommodate and support a respective plurality of turns of the resistive element.

5. A heater according to claim 3, wherein the at least two layers fix said resistive element therebetween at a central region thereof.

6. A heater according to claim 4, wherein the at least two layers fix said resistive element therebetween at a central region thereof.

7. A heater according to claim 5, wherein the supporting structure comprises a third layer made of insulating material arranged in a distal position from the two layers in order to support said resistive element and provide a duct for the passage of air.

8. A heater according to claim 6, wherein the supporting structure comprises a third layer made of insulating material arranged in a distal position from the two layers in order to support said resistive element and provide a duct for the passage of air.

9. A heater according to claim 1, wherein more than one resistive element is provided.

10. A heater according to claim 7, wherein each layer is made of a material chosen from a group comprising mica, steatite, cordierite, or the like.

11. A heater according to claim 8, wherein each layer is made of a material chosen from a group comprising mica, steatite, cordierite, or the like.

12. A heater according to claim 1, wherein each resistive element is made of a material chosen from the group comprising resistive FeCrAl—FeNiCr alloys, or the like.

13. A heater according to claim 9, wherein each resistive element is made of a material chosen from the group comprising resistive FeCrAl—FeNiCr alloys, or the like.
